(19) United States
(12) Patent Application Publication
(10) Pub. No.: US 2025/0002681 A1
(43) Pub. Date: Jan. 2, 2025

(54) X-SPY FORMULATIONS

(71) Applicant: SIFTEX EQUIPMENT COMPANY, INC., South Windsor, CT (US)

(72) Inventor: Jonas ANGUS, Harvard, MA (US)

(21) Appl. No.: 18/752,978

(22) Filed: Jun. 25, 2024

Related U.S. Application Data
(60) Provisional application No. 63/511,679, filed on Jul. 2, 2023.

(51) Int. Cl. C08K 3/22; C08K 3/04; C08K 5/20; C08L 75/04

(52) U.S. Cl. CPC C08K 3/22; C08K 3/04; C08K 5/20; C08L 75/04; C08K 2003/2241; C08K 2003/2275

(57) ABSTRACT

A thermoplastic elastomer composition which imparts x-ray detection, metal detection and magnetic susceptibility to plastic and rubber compounds, permitting manufacturers to easily detect unwanted plastic and rubber fragment contamination generated during manufacturing processes.

### CROSS REFERENCE TO RELATED APPLICATIONS

This application claims priority to U.S. Provisional Patent Application No. 63/511,679 filed on Jul. 2, 2023 in the name of Jonas ANGUS, which is hereby incorporated by reference herein in its entirety.

### FIELD

The present invention relates to thermoplastic elastomer compositions having improved x-ray detectability and metal detectability, as well as electro-static discharge control. In addition to the thermoplastic elastomer compositions, methods of making and of improving x-ray and/or metal detectability in thermoplastics, and articles prepared therefrom, are disclosed herein.

### BACKGROUND

Metal detectors are commonly used in the manufacturing process to detect metallic contaminants that typically arise from wear and tear of machines resulting from routine use. However, metal detectors are not capable of detecting contaminants coming from plastic components in the manufacturing process. Recalls of consumer products due to foreign matter contamination costs manufacturers millions of dollars each year in lost product, and reputational damage. Further, health and safety issues caused by electro-static charges reaching their minimum ignition energy include increased risk of explosion of combustible dusts and vapors, machinery and electronic equipment damage, and injuries to humans. X-ray detectors can be used to detect plastics; however, many plastics are transparent to X-rays. Elements having higher atomic numbers than carbon have to be introduced into the plastic, either in the form of additives (e.g., glass, pigments, etc.) or incorporated into the polymer chain, to enable many plastics to show any level of X-ray contrast. Disadvantageously, the addition of glass or other inorganic fillers leads to loss of gloss and low transparency as well as reduction in flow and impact properties of the plastic.

There continues to be a need to reduce the risk of contamination in manufacturing processes from unwanted plastic and rubber fragments by using detection means such as x-ray, metal detectors, and magnetic traps to locate said contamination, and subsequently eliminate the contamination. Towards that end, a formulation which imparts x-ray detection, metal detection and magnetic susceptibility to plastic and rubber compounds is disclosed herein. In addition, European Union (EU) ATEX (ATmospheres EXplosibles)-compliant dissipation of electro-static charge generated by particles moving through or across rubber and plastic components can be achieved with films, sheets, tubes, hoses, and custom parts made with the formulation disclosed herein.

### SUMMARY

In some aspects, a thermoplastic elastomer composition comprising at least one thermoplastic elastomer, at least one metal detectable agent, and at least one x-ray detectable agent is described.

In some other aspects, a thermoplastic elastomer composition comprising at least one thermoplastic elastomer, at least one metal detectable agent, at least one x-ray detectable agent, and at least one anti-static agent is described.

In still other aspects, a thermoplastic elastomer composition comprising at least one thermoplastic elastomer, at least one metal detectable agent, at least one x-ray detectable agent, and at least one lubricant is described.

In other aspects, a thermoplastic elastomer composition comprising at least one thermoplastic elastomer, at least one metal detectable agent, at least one x-ray detectable agent, at least one lubricant, and at least one colorant is described.

In yet other aspects, a thermoplastic elastomer composition comprising at least one thermoplastic elastomer, at least one metal detectable agent, at least one x-ray detectable agent, at least one anti-static agent, and at least one lubricant is described.

In other aspects, a thermoplastic elastomer composition comprising at least one thermoplastic elastomer, at least one metal detectable agent, at least one x-ray detectable agent, at least one anti-static agent, at least one colorant, and at least one lubricant is described.

Other aspects include pellets prepared using the thermoplastic elastomer compositions described herein, as well as products comprising the thermoplastic elastomer compositions described herein, which advantageously are metal detectable, x-ray detectable, and have electro-static discharge control.

Other aspects, features and embodiments of the invention will be more fully apparent from the ensuing disclosure and appended claims.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, “combination” is inclusive of blends, mixtures, alloys, reaction products, and the like.

“Thermoplastic” describes a material that softens when exposed to heat and which substantially returns to a non-softened condition when cooled to room temperature.

“Plastic” refers to any of various organic compounds produced by polymerization, capable of being molded, extruded, cast into various shapes and films, or drawn into filaments used as textile fibers.

“Polymers” include, but are not limited to, homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to isotactic, syndiotactic and atactic symmetries.

As used herein, “shore hardness” is a measure of a particular material's resistance to indentation. The term “Shore A hardness” and “Shore D hardness,” as described herein, refers to the hardness of a material as measured according to ASTM D2240. “Shore A” materials typically include mold rubbers and semi-rigid plastics and “Shore D” materials typically include hard rubbers, semi-rigid plastics and hard plastics.

As used herein, an “elastomer” refers to a material or composite which can be elongated by at least 25 percent of its relaxed length and which will recover, upon release of the applied force, at least 10 percent of its elongation.

### Thermoplastic Elastomer Compositions

In a first aspect, a compounding of ingredients including polymers and/or rubber ingredients to yield a thermoplastic elastomer composition is disclosed, wherein the resulting products made from the thermoplastic elastomer compositions offer detectability via x-ray, metal detectors and removal via magnetic traps, as well as electro-static discharge control per the EU ATEX standard. The resulting products made from the thermoplastic elastomer compositions can be prepared many forms including, but not limited to, films, sheets, tubes, hoses, and custom parts.

In some embodiments, the thermoplastic elastomer composition comprises, consists of, or consists essentially of at least one thermoplastic elastomer, at least one metal detectable agent, and at least one x-ray detectable agent. In some embodiments, the thermoplastic elastomer composition comprises, consists of, or consists essentially of at least one thermoplastic elastomer, at least one metal detectable agent, at least one anti-static agent, and at least one x-ray detectable agent. When present, the at least one thermoplastic elastomer, at least one metal detectable agent, at least one anti-static agent, and at least one x-ray detectable agent are considered the “components” of the thermoplastic elastomer composition.

In some embodiments, the thermoplastic elastomer composition can further include various other additives, where the additives are selected to obtain the preferred characteristics of the thermoplastic elastomer composition. Mixtures of additives may be used. Such additives may be mixed at a suitable time during the mixing of the components of the thermoplastic elastomer composition to produce same. Additives contemplated herein include, but are not limited to, hardeners or impact modifiers, fillers, adhesion agents, chemical resistance agents, abrasion resistant agents, colorants including dyes and pigments, antioxidants, heat stabilizers, light and/or UV light stabilizers, plasticizers, lubricants, mold release agents, flame retardants, anti-drip agents, radiation (gamma) stabilizers, crosslinking agents, and the like, or a combination including at least one of the foregoing additives. For example, in some embodiments, the thermoplastic elastomer composition further comprises at least one lubricant. In some embodiments, the thermoplastic elastomer composition further comprises at least one hardener. In some embodiments, the thermoplastic elastomer composition further comprises at least one colorant. In some other embodiments, the thermoplastic elastomer composition further comprises at least one lubricant and at least one colorant. It should be appreciated by the person skilled in the art that some additives and/or components have multiple attributes, e.g., an additive can be both a hardener and a chemical resistance agent, etc.

Accordingly, in some embodiments, the thermoplastic elastomer composition comprises, consists of, or consists essentially of at least one thermoplastic elastomer, at least one metal detectable agent, at least one x-ray detectable agent, and at least one lubricant. In some embodiments, the thermoplastic elastomer composition comprises, consists of, or consists essentially of at least one thermoplastic elastomer, at least one metal detectable agent, at least one anti-static agent, at least one x-ray detectable agent, and at least one lubricant. In some embodiments, the thermoplastic elastomer composition comprises, consists of, or consists essentially of at least one thermoplastic elastomer, at least one metal detectable agent, at least one x-ray detectable agent, at least one lubricant, and at least one colorant. In some embodiments, the thermoplastic elastomer composition comprises, consists of, or consists essentially of at least one thermoplastic elastomer, at least one metal detectable agent, at least one anti-static agent, at least one x-ray detectable agent, at least one lubricant, and at least one colorant.

In some embodiments, the thermoplastic elastomer compositions are substantially devoid of polysiloxane-polycarbonate and polycarbonate.

In some embodiments, the thermoplastic elastomer composition is substantially devoid of any crosslinking agents including, but not limited to polyisocyanates, melamines, agents with active —NCO groups, aziridines, polycarbodiimides.

### a. Thermoplastic Elastomer

Various thermoplastic elastomers are considered suitable for the present thermoplastic elastomer composition. In some embodiments, the thermoplastic elastomer may comprise vibration damping thermoplastic elastomer (VDT), thermoplastic polyurethane (TPU), thermoplastic vulcanizate (TPV), thermoplastic polyolefins (TPO), thermoplastic copolyester elastomer (TPC), polyamide thermoplastic elastomer (TPA), thermoplastic styrenic elastomer (TPS), styrene copolymer (e.g., a styrene-butadiene block copolymer (SBC)), or combinations thereof.

In some embodiments, the thermoplastic elastomer comprises TPU. The thermoplastic polyurethane can include hard and soft segments. The hard segments can comprise or consist of urethane segments (e.g., isocyanate-derived segments). The soft segments can comprise or consist of alkoxy segments (e.g., polyol-derived segments including polyether segments, or polyester segments, or a combination of polyether segments and polyester segments). The polyurethane can comprise or consist essentially of an elastomeric polyurethane having repeating hard segments and repeating soft segments. In some embodiments, suitable thermoplastic urethanes include aromatic polyester polyurethanes, aromatic polyether polyurethanes, aliphatic polyester polyurethanes, or aliphatic polyether polyurethanes. Suitable thermoplastic polyurethanes can have a weight average molecular weight (Mw) of from 25,000 to 400,000 g/mol, or from 40,000 to 200,000 g/mol, as determined, for example, by gel permeation chromatography (GPC) using polystyrene standards. In some embodiments, useful thermoplastic polyurethanes include, for example, those sold under the tradenames ESTANE®, PELLETHANE®, and PEARLTHANE® from Lubrizol Advanced Materials, Inc., Cleveland, Ohio; AVALON®, IROGRAN®, and KRYSTALGRAN® from Huntsman International LLC; ELASTOLLAN® from BASF Polyurethanes GMBH; and TEXIN® from Covestro LLC. In some embodiments, the TPU comprises PEARLTHANE® D15N85 or D15N70.

In some embodiments, the thermoplastic elastomer is selected such that the final product has a shore hardness selected from Shore A hardness greater than or equal to 15 to Shore D hardness less than or equal to 70. In some embodiments, the thermoplastic elastomer may comprise a Shore A hardness in a range from greater than or equal to about 15 to about 100. In embodiments, the thermoplastic elastomer may comprise a Shore A hardness from 15 to 20, from 20 to 30, from 30 to 40, from 40 to 50, from 50 to 60, from 60 to 70, from 70 to 80, from 80 to 90, from 90 to 100, or any and all combinations and sub-ranges formed from these endpoints. In some embodiments, the thermoplastic elastomer may comprise a Shore D hardness greater than or equal to 0 to less than or equal to 70. In embodiments, the thermoplastic elastomer may comprise a Shore D hardness from 0 to 10, from 10 to 20, from 20 to 30, from 30 to 40, from 40 to 50, from 50 to 60, from 60 to 70, or any and all combinations and sub-ranges formed from these endpoints.

In some embodiments, the at least one thermoplastic elastomer is included in amounts greater than or equal to about 40 wt %, based on the total weight of the composition, such that the thermoplastic elastomer may impart the desired hardness, tensile elongation, and strength at break to the product. In embodiments, the amount of the at least one thermoplastic elastomer may be greater than or equal to about 50 wt %, greater than or equal to about 60 wt %, or greater than or equal to about 70 wt %. In embodiments, the amount of thermoplastic elastomer may be less than or equal to about 80 wt %, less than or equal to about 78 wt %, less than or equal to about 75 wt %, or less than or equal to about 72 wt %, based on the total weight of the thermoplastic elastomer composition. In embodiments, the amount of thermoplastic elastomer may be from about 40 wt % to 72 wt %, from about 40 wt % to 50 wt %, from about 40 wt % to 45 wt %, from about 60 wt % to 70 wt %, from about 55 wt % to 60 wt %, from about 60 wt % to 65 wt %, from about 65 wt % to 70 wt %, based on the total weight of the thermoplastic elastomer composition, or any and all sub-ranges formed from any of these endpoints. In some embodiments, the amount of thermoplastic elastomer is in a range from about 65 wt % to about 72 wt %, or about 68 wt % to about 72 wt %, or about 63 wt % to about 70 wt %, or about 63 wt % to about 66 wt %, or about 40 wt % to about 50 wt %, or about 40 wt % to about 46 wt %, or about 43 wt % to about 46 wt %, or about 40 wt % to about 42.5 wt %, or about 57 wt % to about 67 wt %, or about 57 wt % to about 65 wt %, or about 61 wt % to about 65 wt %, or about 57.5 wt % to about 60 wt %, based on the total weight of the thermoplastic elastomer composition.

### b. Metal Detectability

The thermoplastic elastomer composition comprises at least one metal detectable agent. The metal detectable agent can be any ferrous or nonferrous metal having good magnetic permeability and/or good electrical conductivity. Most standard metal detectors are capable of detecting materials that are magnetic, such as those containing iron, such as magnetite. In some embodiments, the metal detectable agent is magnetic. Advantageously, when a magnetic metal detectable agent is used, the thermoplastic elastomer composition is also magnetically susceptible and any detected contamination can be easily removed using magnets.

In some embodiments, the metal detectable agent is in the form of particles. The particles as disclosed herein can be used in any suitable morphological form, including but not limited to microparticles, nanoparticles, and particles having various shapes including spheres, rods, faceted crystalline shapes, irregular shapes, and the like. The size of the particles of the metal detectable agent, as measured by the longest dimension, can be described more generally using the median of the distribution of the particle sizes, also referred to as the median particle size (D₅₀).

Metal detectable agents can be used in varying stages of compositional purity, provided any impurities present in the thermoplastic elastomer composition do not significantly adversely affect the selected properties of the thermoplastic elastomer composition. In some embodiments, metal detectable agents can have minor amounts of impurities of less than or equal to 0.1% by weight, more specifically less than or equal to 0.01% by weight, and still more specifically less than or equal to 0.001% by weight, based on the total weight of the metal detectable agent. In some embodiments, the metal detectable agent may be treated or purified to remove or reduce the presence of impurities, where such impurities are initially present (prior to treating or purification) in the metal detectable agent in amounts sufficient to significantly adversely affect the selected properties of the thermoplastic elastomer composition.

The thermoplastic elastomer composition may also include mixtures of metal detectable agents. In some embodiments, the thermoplastic elastomer composition includes metal detectable agent(s) in an amount of about 0.01 to 15% weight, more specifically about 1 to 12% weight, more specifically about 4 to 12% weight, or about 8 to 12% weight, or about 9 to 11% weight, or about 8.5 to about 10.5% weight, or about 8.8 to 9.6% weight, based on the total weight of thermoplastic elastomer composition.

In some embodiments, the metal detectable agents comprise ferrous metals, such as magnetite (Fe₃O₄), selected from within an optimal particle size range. In some embodiments, ferromagnetic fillers based on iron, nickel or cobalt are used as the metal detectable agents. Exemplary iron-containing compounds include iron oxide magnetite, for example, Magnif® 10 (LKAB, Sweden), which comprises Fe₃O₄ and small amounts (<0.5%) of at least one of calcium, magnesium, aluminum, silica, titanium, and vanadium. In some embodiments, the metal detectable agents have a D₅₀ in a range from about 5 microns to about 25 microns, or about 5 microns to about 15 microns, or about 8 microns to about 12 microns. It should be appreciated that the particle size of the metal detectable agent is selected such that select properties (flow, low temperature impact, gloss) of the thermoplastic elastomer composition are maintained.

### c. X-Ray Detectability

The thermoplastic elastomer composition includes at least one X-ray detectable agent. The X-ray detectable agent can be an inorganic compound comprising atoms with an atomic number sufficient to scatter incident X-ray radiation. In some embodiments, the X-ray detectable agent is present in an amount greater than or equal to about 1 percent by weight, more specifically greater than or equal to about 5 percent by weight, and still more specifically greater than or equal to about 10 percent by weight, based on the total weight of the thermoplastic elastomer composition. The thermoplastic composition may also include mixtures of X-ray detectable agents.

In some embodiments, the X-ray detectable agent is in the form of particles, and may, depending upon the type used, be a filler, pigment, or other such class of inorganic material having suitable properties as defined herein. The particles can be used in any suitable morphological form, including but not limited to microparticles, nanoparticles, and particles having various shapes including spheres, rods, faceted crystalline shapes, irregular shapes, and the like. The size of the particles of the X-ray detectable agent, as measured by the longest dimension, can be described more generally using the median of the distribution of the particle sizes, also referred to as the median particle size. Particles of X-ray detectable agent as disclosed herein have a D₅₀ of less than or equal to about 5 micrometers, specifically less than or equal to 2 micrometers, more specifically less than or equal to 1.5 micrometers, and still more specifically less than or equal to about 1 micrometer. In some embodiments, useful X-ray detectable agents have a median particle size about 0.1 to about 0.5 micrometers, specifically about 0.2 to about 0.5 micrometers. In some embodiments, useful X-ray detectable agents have a median particle size about 0.5 to about 1 micrometers, specifically about 0.5 to about 0.9 micrometers.

X ray detectable agents include inorganic pigments, have sufficient X-ray contrast, and do not significantly adversely affect the properties of a thermoplastic elastomer composition prepared therewith. Exemplary inorganic pigments include metal oxide hydroxides and metal oxides such as zinc oxide, titanium dioxides, iron oxides, chromium oxides, cerium oxide, colored alumina oxide particles, or the like. Inorganic pigments can include carbonates, and titanates based on rutile, spinels, priderite, and pseudobrookite pigment structures. As used herein “rutile” is a mineral composed primarily of titanium dioxide (TiO₂) and is the most common natural form of TiO₂, along with its two less abundant polymorphs anatase (having a tetragonal, pseudo-octahedral morphology), and brookite, an orthorhombic mineral. Inorganic pigments can also include carbonates such as calcium and cobalt carbonate, titanates based on rutile such as chromium antimony titanate and nickel antimony titanate, spinels such as cobalt and iron titanates, priderite, and pseudobrookite pigment structures. Other exemplary inorganic pigments include: chromites such as copper chromite black and cobalt chromite green; ferrites such as the pure ferrite spinels that contain magnesium and zinc, mixed chromite/ferrite spinels, and mixed chromium iron pigments identified as Pigment Green 17 or Pigment Brown 29; sulfides and sulfates such as cadmium sulfides and sulfoselenides, cerium sulfides, zinc sulfide, barium sulfate, and strontium sulfate; chromates; silicates such as ultramarine and zirconium silicate and zircon praseodymium yellow pigments; cyanide complexes such as the Fe(II)-Fe(III) cyano complexes (e.g., “Prussian blue”); calcium, lanthanum, and tantalum oxide-nitrides and titanium nitride; manganese and cobalt phosphates; titania-rare earth mixed oxide pigments; luminescent pigments such as sulfides and sulfoselenides, alkaline-earth sulfides and sulfoselenides, oxysulfides, borates, aluminates, gallates, silicates, germinates, halophosphates and phosphates, oxides, arsenates, and vanadates including yttrium vanadates, niobates and tantalates, sulfates, tungstates and molybdates. In some embodiments, the X ray detectable agent comprises titanium dioxide. Advantageously, titanium dioxide is chemically and biologically inert, photo-/chemical corrosion-resistant, non-toxic, and has a relatively low cost.

The thermoplastic elastomer composition may also include mixtures of X-ray detectable agents. In one embodiment, the thermoplastic elastomer composition includes X-ray detectable agent(s) in an amount of about 5 to 30% weight, specifically about 10 to 25% weight, specifically about 15 to 22% weight, or about 17.5 to 22% weight, or about 18.5 to about 21% weight, or about 17.5 to about 19% weight, based on the total weight of thermoplastic elastomer composition.

### d. Anti-Static Agents

The thermoplastic elastomer composition optionally includes at least one anti-static agent. Importantly, the antistaticity is not compromised by aqueous washing but persists semi-permanently. Examples of the anti-static agent include polyether ester amide-based high molecular weight type anti-static agents and/or ionomer-based high molecular weight type anti-static agents. Examples of the polyether ester amide-based high molecular weight type anti-static agent include, as commercially available products, Pelestat® 230, Pelestat® 6500, Pelectron AS, and Pelectron HS (manufactured by Sanyo Chemical Industries, Ltd.). Examples of the ionomer-based high molecular weight type anti-static agents include, as commercially available products, Entira® SD100, Entira® MK400 (manufactured by Dow-Mitsui Polychemicals, Inc.). In some embodiments, the amount of the anti-static agent added is about 5 wt % to about 30 wt %, based on the total weight of the thermoplastic elastomer composition.

In some other embodiments, the anti-static agent comprises carbon black. In some embodiments, the carbon black may be any one or a mixture of two or more selected from furnace black, acetylene black, thermal black, channel black, etc., but the present is not limited thereto. In some embodiments, the carbon black used can be the commercially available Chezacarb AC60 or AC80. Other commercially available carbon blacks include PrintexXE2, PrintexHV (Evonik), Black Pearls 2000, VulcanoxC72, VulcanoxC72 (Cabot), Ketjen Black EC300J, Ketjen Black EC600JD (Akzo Nobel), Ensaco 360 g, Ensaco 350 g, Ensaco 350 p, Ensaco 250 g (Timcal), CL-08 (Continental Carbon), Denka Black HS100, Denka Black HS100, Denka Black HS100 (Denka Chemicals), CD 7087 (Columbian Chemicals), TokaBlack5500 and (TokaiCarbon).

The thermoplastic elastomer composition may also include mixtures of anti-static agents. In one embodiment, the thermoplastic elastomer composition includes anti-static agent(s) in an amount of about 1 to 35% weight, or about 2 to 10% weight, or about 20 to 25% weight, based on the total weight of thermoplastic elastomer composition, and depending on the anti-static agents chosen. For example, in some embodiments, the anti-static agent comprises a carbon black species and the amount of carbon black in the thermoplastic elastomer composition is about 2 to 10% weight, or about 4.5 to about 7.5% weight, or about 4.5 to about 7% weight, or about 5.5 to about 6.5% weight, or about 5 to about 6% weight, based on the total weight of thermoplastic elastomer composition. In some other embodiments, the anti-static agent is a polyether ester amide-based high molecular weight type anti-static agent and the amount of polyether ester amide-based high molecular weight type anti-static agent in the thermoplastic elastomer composition is about 21 to 28% weight, or about 23 to 26% weight, or about 21 to about 26% weight, or about 22 to about 24% weight, based on the total weight of thermoplastic elastomer composition.

### e. Lubricants

The thermoplastic elastomer composition optionally includes at least one lubricant. Waxes may be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. N,N′-ethylene bisstearamide wax is commercially available from Arxada, Inc. under the designation Acrawax® C. Another ethylene bis stearamide that is commercially available is Hi-Lube (Sinwon Chemical, KR). Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin. In some embodiments, the at least one lubricant comprises an ethylenebisstearamide wax, such as Acrawax C or Hi-Lube, which also improves color dispersion, mold release, and imparts anti-static properties to the product.

In some embodiments, the at least one lubricant is plant-based, for example, comprises the fatty acid amide erucamide, which is sold commercially as Crodamide® ER.

The thermoplastic elastomer composition may also include mixtures of lubricants. In one embodiment, the thermoplastic elastomer composition includes lubricant(s) in an amount of about 0.01 to 1% weight, or about 0.05 to 0.5% weight, or about 0.1 to 0.5% weight, or about 0.1 to 0.4% weight, based on the total weight of thermoplastic elastomer composition.

In some embodiments, the at least one lubricant is present in the thermoplastic elastomer composition, i.e., substantially homogeneously distributed in the composition. In some embodiments, pellets of the thermoplastic elastomer composition are dusted with additional lubricant(s) to prevent agglomeration. In some other embodiments, the at least one lubricant is present in the thermoplastic elastomer composition, i.e., substantially homogeneously distributed in the composition, and pellets of the thermoplastic elastomer composition are dusted with additional lubricant(s) to prevent agglomeration. When the at least lubricant is present on and in the pellets of the thermoplastic elastomer composition, the amount of lubricant in the thermoplastic elastomer composition is the total of both the amount in the pellets and dusted on the pellets.

### f. Colorants

The thermoplastic elastomer composition optionally includes at least one colorant. In some embodiments, the at least one colorant is preblended/precompounded with the other components of the thermoplastic elastomer composition. In some embodiments, the at least one colorant is fed separately to thermoplastic elastomer composition at the extruding or mixing device/step.

The colorant may include, for example, submicron colorant particles having a size of, for example, from about 50 to about 500 nanometers in volume average diameter and, in embodiments, of from about 100 to about 400 nanometers in volume average diameter. In some embodiments, colorants are selected from pigments, dyes, mixtures of pigments and dyes, mixtures of pigments, mixtures of dyes, and the like. The colorant may be, for example, carbon black, cyan, yellow, magenta, red, orange, brown, green, blue, violet, or mixtures thereof. In some embodiments, the colorant is a pigment, for example, carbon black, phthalocyanines, quinacridones or RHODAMINE B™ type, red, green, orange, brown, violet, yellow, fluorescent colorants, and the like. Exemplary colorants include carbon black like REGAL 330® magnetites; Mobay magnetites including M08029™, M08060™; Columbian magnetites; MAPICO BLACKS™ and surface treated magnetites; Pfizer magnetites including CB4799™, CB5300™ CB5600™, MCX6369™; Bayer magnetites including, BAYFERROX 8600™, 8610™; Northern Pigments magnetites including, NP-604™, NP-608™; Magnox magnetites including TMB-100™, or TMB-104™ HELIOGEN BLUE L6900™, D6840™, D7080™, D7020™, PYLAM OIL BLUE™, PYLAM OIL YELLOW™, PIGMENT BLUE 1™ available from Paul Uhlich and Company, Inc.; PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario; NOVAPERM YELLOW FGL™, HOSTAPERM PINK E™ from Hoechst; and CINQUASIA MAGENTA™ available from E.I. DuPont de Nemours and Company. Other colorants include 2,9-dimethyl-substituted quinacridone and anthraquinone dye identified in the Color Index as CI 60710, CI Dispersed Red 15, diazo dye identified in the Color Index as CI 26050, CI Solvent Red 19, copper tetra(octadecyl sulfonamido) phthalocyanine, x-copper phthalocyanine pigment listed in the Color Index as CI 74160, CI Pigment Blue, Anthrathrene Blue identified in the Color Index as CI 69810, Special Blue X-2137, diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33,2,5-dimethoxy-4-sulfonanilide phenylazo-4′-chloro-2,5-dimethoxy acetoacetanilide, Yellow 180, and Permanent Yellow FGL. Organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53, Neopen Black X55. In some embodiments, colorants include Pigment Blue 15:3 having a Color Index Constitution Number of 74160, Magenta Pigment Red 81:3 having a Color Index Constitution Number of 45160:3, Yellow 17 having a Color Index Constitution Number of 21105, and known dyes such as food dyes, yellow, blue, green, red, magenta dyes, and the like. In some other embodiments, a magenta pigment, Pigment Red 122 (2,9-dimethylquinacridone), Pigment Red 185, Pigment Red 192, Pigment Red 202, Pigment Red 206, Pigment Red 235, Pigment Red 269, combinations thereof, and the like, may be utilized as the colorants. In some embodiments, the colorants can be PANTONE® colors (Pantone, Inc., Moonachie, NJ), based on the PANTONE® color guide, including PANTONE® Orange, PANTONE® yellow, PANTONE® blue, and the like.

The thermoplastic elastomer composition may also include mixtures of colorants. In one embodiment, the thermoplastic elastomer composition includes colorant(s) in an amount of about 1 to 15% by weight, or about 5 to about 10% weight, based on the total weight of thermoplastic elastomer composition and based on the specific colorant used.

In some embodiments, when the at least one metal detectable agent comprises magnetite (e.g., Magnif 10F), the thermoplastic elastomer composition is a very dark grey before the addition of the at least one colorant. Applicant has surprisingly been able to adapt the greyish thermoplastic elastomer composition to any color using the process described herein

### g. Exemplary Embodiments of the Thermoplastic Elastomer Composition

In some embodiments, the thermoplastic elastomer composition comprises, consists of, or consists essentially of at least one thermoplastic elastomer in an amount from about 40 wt % to about 80 wt %, at least one metal detectable agent in an amount of about 0.01 wt % to about 15 wt %, at least one x-ray detectable agent in an amount of about 5 wt % to about 30 wt %, and at least one lubricant in an amount of about 0.01 wt % to about 1 wt %, based on the total weight of the composition. In some embodiments, the thermoplastic elastomer composition comprises, consists of, or consists essentially of at least one thermoplastic elastomer in an amount from about 40 wt % to about 80 wt %, at least one metal detectable agent in an amount of about 0.01 wt % to about 15 wt %, at least one x-ray detectable agent in an amount of about 5 wt % to about 30 wt %, at least one anti-static agent in an amount of about 1 wt % to about 35 wt %, and at least one lubricant in an amount of about 0.01 wt % to about 1 wt %, based on the total weight of the composition. In some embodiments, the thermoplastic elastomer composition comprises, consists of, or consists essentially of at least one thermoplastic elastomer in an amount from about 40 wt % to about 80 wt %, at least one metal detectable agent in an amount of about 0.01 wt % to about 15 wt %, at least one x-ray detectable agent in an amount of about 5 wt % to about 30 wt %, at least one colorant in an amount of about 1 wt % to about 15 wt %, and at least one lubricant in an amount of about 0.01 wt % to about 1 wt %, based on the total weight of the composition. In some embodiments, the thermoplastic elastomer composition comprises, consists of, or consists essentially of at least one thermoplastic elastomer in an amount from about 40 wt % to about 80 wt %, at least one metal detectable agent in an amount of about 0.01 wt % to about 15 wt %, at least one x-ray detectable agent in an amount of about 5 wt % to about 30 wt %, at least one anti-static agent in an amount of about 1 wt % to about 35 wt %, at least one colorant in an amount of about 1 wt % to about 15 wt %, and at least one lubricant in an amount of about 0.01 wt % to about 1 wt %, based on the total weight of the composition.

In some other embodiments, the thermoplastic elastomer composition comprises, consists of, or consists essentially of at least one thermoplastic elastomer in an amount from about 65 wt % to about 72 wt %, at least one metal detectable agent in an amount of about 8 wt % to about 12 wt %, at least one x-ray detectable agent in an amount of about 17.5 wt % to about 22 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 65 wt % to about 72 wt %, a magnetite-containing component in an amount of about 8 wt % to about 12 wt %, titanium dioxide in an amount of about 17.5 wt % to about 22 wt %, and erucamide or other lubricant in an amount of about 0.1 wt % to about 0.4 wt %, based on the total weight of the composition. In some other embodiments, the thermoplastic elastomer composition comprises, consists of, or consists essentially of at least one thermoplastic elastomer in an amount from about 68 wt % to about 72 wt %, at least one metal detectable agent in an amount of about 9 wt % to about 11 wt %, at least one x-ray detectable agent in an amount of about 18.5 wt % to about 21 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 68 wt % to about 72 wt %, a magnetite-containing component in an amount of about 9 wt % to about 11 wt %, titanium dioxide in an amount of about 18.5 wt % to about 21 wt %, and erucamide or other lubricant in an amount of about 0.1 wt % to about 0.4 wt %, based on the total weight of the composition.

In some other embodiments, the thermoplastic elastomer composition comprises, consists of, or consists essentially of at least one thermoplastic elastomer in an amount from about 40 wt % to about 50 wt %, at least one metal detectable agent in an amount of about 8 wt % to about 12 wt %, at least one x-ray detectable agent in an amount of about 17.5 wt % to about 22 wt %, at least one anti-static agent in an amount of about 21 wt % to about 28 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 40 wt % to about 50 wt %, a magnetite-containing component in an amount of about 8 wt % to about 12 wt %, titanium dioxide in an amount of about 17.5 wt % to about 22 wt %, a polyether ester amide-based high molecular weight type anti-static agent in an amount of about 21 wt % to about 28 wt %, and erucamide or other lubricant in an amount of about 0.1 wt % to about 0.4 wt %, based on the total weight of the composition. In some other embodiments, the thermoplastic elastomer composition comprises, consists of, or consists essentially of at least one thermoplastic elastomer in an amount from about 43 wt % to about 46 wt %, at least one metal detectable agent in an amount of about 9 wt % to about 11 wt %, at least one x-ray detectable agent in an amount of about 18.5 wt % to about 21 wt %, at least one anti-static agent in an amount of about 23 wt % to about 26 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 43 wt % to about 46 wt %, a magnetite-containing component in an amount of about 9 wt % to about 11 wt %, titanium dioxide in an amount of about 18.5 wt % to about 21 wt %, a polyether ester amide-based high molecular weight type anti-static agent in an amount of about 23 wt % to about 26 wt %, and erucamide or other lubricant in an amount of about 0.1 wt % to about 0.4 wt %, based on the total weight of the composition.

In some other embodiments, the thermoplastic elastomer composition comprises, consists of, or consists essentially of at least one thermoplastic elastomer in an amount from about 57 wt % to about 67 wt %, at least one metal detectable agent in an amount of about 8 wt % to about 12 wt %, at least one x-ray detectable agent in an amount of about 17.5 wt % to about 22 wt %, at least one anti-static agent in an amount of about 4.5 wt % to about 7.5 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 57 wt % to about 67 wt %, a magnetite-containing component in an amount of about 8 wt % to about 12 wt %, titanium dioxide in an amount of about 17.5 wt % to about 22 wt %, a carbon black type anti-static agent in an amount of about 4.5 wt % to about 7.5 wt %, and erucamide or other lubricant in an amount of about 0.1 wt % to about 0.4 wt %, based on the total weight of the composition. In some other embodiments, the thermoplastic elastomer composition comprises, consists of, or consists essentially of at least one thermoplastic elastomer in an amount from about 61 wt % to about 65 wt %, at least one metal detectable agent in an amount of about 9 wt % to about 11 wt %, at least one x-ray detectable agent in an amount of about 18.5 wt % to about 21 wt %, at least one anti-static agent in an amount of about 5.5 wt % to about 6.5 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 61 wt % to about 65 wt %, a magnetite-containing component in an amount of about 9 wt % to about 11 wt %, titanium dioxide in an amount of about 18.5 wt % to about 21 wt %, a carbon black type anti-static agent in an amount of about 5.5 wt % to about 6.5 wt %, and erucamide or other lubricant in an amount of about 0.1 wt % to about 0.4 wt %, based on the total weight of the composition.

In some other embodiments, the thermoplastic elastomer composition comprises, consists of, or consists essentially of at least one thermoplastic elastomer in an amount from about 63 wt % to about 70 wt %, at least one metal detectable agent in an amount of about 8.5 wt % to about 10.5 wt %, at least one x-ray detectable agent in an amount of about 17.5 wt % to about 22 wt %, at least one colorant in an amount of about 1 wt % to about 15 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 63 wt % to about 70 wt %, a magnetite-containing component in an amount of about 8.5 wt % to about 10.5 wt %, titanium dioxide in an amount of about 17.5 wt % to about 22 wt %, erucamide or other lubricant in an amount of about 0.1 wt % to about 0.4 wt %, and at least one colorant in an amount of about 1 wt % to about 15 wt %, based on the total weight of the composition. In some other embodiments, the thermoplastic elastomer composition comprises, consists of, or consists essentially of at least one thermoplastic elastomer in an amount from about 63 wt % to about 66 wt %, at least one metal detectable agent in an amount of about 8.8 wt % to about 9.6 wt %, at least one x-ray detectable agent in an amount of about 17.5 wt % to about 19 wt %, at least one colorant in an amount of about 5 wt % to about 10 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 63 wt % to about 66 wt %, a magnetite-containing component in an amount of about 8.8 wt % to about 9.6 wt %, titanium dioxide in an amount of about 17.5 wt % to about 19 wt %, erucamide or other lubricant in an amount of about 0.1 wt % to about 0.4 wt %, and at least one colorant in an amount of about 5 wt % to about 10 wt %, based on the total weight of the composition.

In some other embodiments, the thermoplastic elastomer composition comprises, consists of, or consists essentially of at least one thermoplastic elastomer in an amount from about 40 wt % to about 46 wt %, at least one metal detectable agent in an amount of about 8.5 wt % to about 10.5 wt %, at least one x-ray detectable agent in an amount of about 17.5 wt % to about 22 wt %, at least one anti-static agent in an amount of about 21 wt % to about 26 wt %, at least one colorant in an amount of about 1 wt % to about 15 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 40 wt % to about 46 wt %, a magnetite-containing component in an amount of about 8.5 wt % to about 10.5 wt %, titanium dioxide in an amount of about 17.5 wt % to about 22 wt %, a polyether ester amide-based high molecular weight type anti-static agent in an amount of about 21 wt % to about 26 wt %, erucamide or other lubricant in an amount of about 0.1 wt % to about 0.4 wt %, at least one colorant in an amount of about 1 wt % to about 15 wt %, based on the total weight of the composition. In some other embodiments, the thermoplastic elastomer composition comprises, consists of, or consists essentially of at least one thermoplastic elastomer in an amount from about 40 wt % to about 42.5 wt %, at least one metal detectable agent in an amount of about 8.8 wt % to about 9.6 wt %, at least one x-ray detectable agent in an amount of about 17.5 wt % to about 19 wt %, at least one anti-static agent in an amount of about 22 wt % to about 24 wt %, at least one colorant in an amount of about 5 wt % to about 10 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 40 wt % to about 42.5 wt %, a magnetite-containing component in an amount of about 8.8 wt % to about 9.6 wt %, titanium dioxide in an amount of about 17.5 wt % to about 19 wt %, a polyether ester amide-based high molecular weight type anti-static agent in an amount of about 22 wt % to about 24 wt %, at least one colorant in an amount of about 5 wt % to about 10 wt %, and erucamide or other lubricant in an amount of about 0.1 wt % to about 0.4 wt %, based on the total weight of the composition.

In some other embodiments, the thermoplastic elastomer composition comprises, consists of, or consists essentially of at least one thermoplastic elastomer in an amount from about 57 wt % to about 65 wt %, at least one metal detectable agent in an amount of about 8.5 wt % to about 10.5 wt %, at least one x-ray detectable agent in an amount of about 17.5 wt % to about 22 wt %, at least one anti-static agent in an amount of about 4.5 wt % to about 7 wt %, at least one colorant in an amount of about 1 wt % to about 15 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 57 wt % to about 65 wt %, a magnetite-containing component in an amount of about 8.5 wt % to about 10.5 wt %, titanium dioxide in an amount of about 17.5 wt % to about 22 wt %, a carbon black type anti-static agent in an amount of about 4.5 wt % to about 7 wt %, erucamide or other lubricant in an amount of about 0.1 wt % to about 0.4 wt %, at least one colorant in an amount of about 1 wt % to about 15 wt %, based on the total weight of the composition. In some other embodiments, the thermoplastic elastomer composition comprises, consists of, or consists essentially of at least one thermoplastic elastomer in an amount from about 57.5 wt % to about 60 wt %, at least one metal detectable agent in an amount of about 8.8 wt % to about 9.6 wt %, at least one x-ray detectable agent in an amount of about 17.5 wt % to about 19 wt %, at least one anti-static agent in an amount of about 5 wt % to about 6 wt %, at least one colorant in an amount of about 5 wt % to about 10 wt %, and at least one lubricant in an amount of about 0.1 wt % to about 0.4 wt %, based on the total weight of the composition. In some exemplary embodiments, the thermoplastic elastomer composition comprises, consists of, or consists essentially of TPU in an amount from about 57.5 wt % to about 60 wt %, a magnetite-containing component in an amount of about 8.8 wt % to about 9.6 wt %, titanium dioxide in an amount of about 17.5 wt % to about 19 wt %, a carbon black type anti-static agent in an amount of about 5 wt % to about 6 wt %, erucamide or other lubricant in an amount of about 0.1 wt % to about 0.4 wt %, at least one colorant in an amount of about 5 wt % to about 10 wt %, based on the total weight of the composition.

### Methods of Making and Products Made

In some embodiments, the thermoplastic elastomer composition described herein can be produced by kneading the components and optional additives by a heretofore known method. The kneading can be performed after a mixing step is carried out. The mixing step may be carried out by mixing the components of the composition all at the same time or in sequence, and the mixing can be performed with, for example, a plastomill, a Henschel mixer, a V-blender, a ribbon blender, a tumbler blender, a kneader or a kneader-ruder. For the kneading, a method may be employed involving melt kneading using, for example, a single-screw extruder, a twin-screw extruder, a plastomill, a kneader, a kneader-ruder or a Banbury mixer, and then granulation, molding or grinding, for production. For the kneading, the components and optional additives of the composition may be introduced into a kneading unit all at the same time or in sequence, and it is also possible to collectively introduce the mixture which has undergone the mixing step. After kneading, the resulting mixture can be pelleted and the pellets dried, as understood by the person skilled in the art. It should be appreciated by the person skilled in the art that the resulting mixture after kneading can be sent straight to product production (e.g., molding) without being pelletized.

In some embodiments, at least one thermoplastic elastomer, at least one metal detectable agent, and at least one x-ray detectable agent are mixed and pelleted. In some embodiments, at least one thermoplastic elastomer, at least one metal detectable agent, at least one anti-static agent, and at least one x-ray detectable agent are mixed and pelleted. In some embodiments, at least one thermoplastic elastomer, at least one metal detectable agent, at least one x-ray detectable agent, and at least one lubricant are mixed and pelleted. In some embodiments, at least one thermoplastic elastomer, at least one metal detectable agent, at least one anti-static agent, at least one x-ray detectable agent, and at least one lubricant are mixed and pelleted. In some embodiments, at least one thermoplastic elastomer, at least one metal detectable agent, at least one x-ray detectable agent, at least one lubricant, and at least one colorant are mixed and pelleted. In some embodiments, at least one thermoplastic elastomer, at least one metal detectable agent, at least one anti-static agent, at least one x-ray detectable agent, at least one lubricant, and at least one colorant are mixed and pelleted.

In some embodiments, after drying the pellets, the pellets are dusted with some amount of additional lubricant to minimize agglomeration of the pellets.

Accordingly, in a second aspect, the pellets produced from the thermoplastic elastomer composition are described. The pellets can be used immediately to produced a product or packaged for sale for production elsewhere. In some embodiments, a thermoplastic elastomer pellet comprises, consists of, or consists essentially of at least one thermoplastic elastomer, at least one metal detectable agent, and at least one x-ray detectable agent. In some embodiments, the thermoplastic elastomer composition pellet comprises, consists of, or consists essentially of at least one thermoplastic elastomer, at least one metal detectable agent, at least one anti-static agent, and at least one x-ray detectable agent. In some embodiments, the thermoplastic elastomer composition pellet can further include various other additives including, but are not limited to, hardeners or impact modifiers, fillers, adhesion agents, chemical resistance agents, abrasion resistant agents, colorants including dyes and pigments, antioxidants, heat stabilizers, light and/or UV light stabilizers, plasticizers, lubricants, mold release agents, flame retardants, anti-drip agents, radiation (gamma) stabilizers, crosslinking agents, and the like, or a combination including at least one of the foregoing additives. Accordingly, in some embodiments, the thermoplastic elastomer composition pellet comprises, consists of, or consists essentially of at least one thermoplastic elastomer, at least one metal detectable agent, at least one x-ray detectable agent, and at least one lubricant. In some embodiments, the thermoplastic elastomer composition pellet comprises, consists of, or consists essentially of at least one thermoplastic elastomer, at least one metal detectable agent, at least one anti-static agent, at least one x-ray detectable agent, and at least one lubricant. In some embodiments, the thermoplastic elastomer composition pellet comprises, consists of, or consists essentially of at least one thermoplastic elastomer, at least one metal detectable agent, at least one x-ray detectable agent, at least one lubricant, and at least one colorant. In some embodiments, the thermoplastic elastomer composition pellet comprises, consists of, or consists essentially of at least one thermoplastic elastomer, at least one metal detectable agent, at least one anti-static agent, at least one x-ray detectable agent, at least one lubricant, and at least one colorant.

In some embodiments, thermoplastic elastomer composition pellet can be appropriately molded by a heretofore known method. Examples of the molding method include injection molding, various kinds of extrusion, compression molding, calendaring, blow molding, press molding, slush molding, rotational molding, film molding (e.g. casting, tentering, inflation), and vacuum forming. In addition, using a known chemical foaming agent or a known physical foaming agent such as carbon dioxide gas, nitrogen gas or water, the composition can be foamed by a known method during molding to form a foam.

Advantageously, products made from the thermoplastic elastomer composition as described herein are X-ray detectable, metal detectable, have magnetic susceptibility, optionally anti-static discharging ability, and excellent surface resistivity and is not particularly limited in application. As a product, for example, the thermoplastic elastomer composition and pellets are suitable for various known applications such as automobile parts, civil engineering and building materials, electrical and electronic parts, sanitary goods, films or sheets, foams, and artificial leather. Using the thermoplastic elastomer compositions and pellets described herein allows product manufacturers to reduce the risk of contamination from unwanted plastic and rubber fragments in manufacturing processes by using detection means such as x-ray, metal detectors, and magnetic traps to locate said contamination, and subsequently eliminate the contamination prior to providing the products to the purchasers.

In some embodiments, the products made from the thermoplastic elastomer composition as described herein have a polymeric makeup that consists of only the thermoplastic elastomer composition described herein. In other words, only the thermoplastic elastomer composition pellets described herein are molded. In some embodiments, the products made from the thermoplastic elastomer composition as described herein have a polymeric makeup that comprises the thermoplastic elastomer composition described herein. In other words, a mixture of thermoplastic elastomer composition pellets described herein plus another polymer and/or rubber are mixed together and molded, as understood by the person skilled in the art. In some embodiments, when a mixture of thermoplastic elastomer composition pellets plus another polymer and/or rubber is molded the percent by weight of thermoplastic elastomer composition pellets in the overall mixture, based on the total weight of the mixture, is about 1-90 wt %, or about 1-10 wt %, or about 10-20 wt %, or about 20-30 wt %, or about 30-40 wt %, or about 40-50 wt %, or about 50-60 wt %, or about 60-70 wt %, or about 70-80 wt %, or about 80-90 wt %, or any combination of any of the foregoing values, e.g., about 1 to about 20 wt %, etc.

The features and advantages of the invention are more fully shown by the illustrative examples discussed below.

### EXAMPLES

A formulation for a blue thermoplastic elastomer composition that is X-ray detectable, metal detectable and has magnetic susceptibility includes:

| material | % formulation |
|---|---|
| TPU D15N70 | 69.8 |
| Magnif 10F | 10 |
| TiO₂ | 20 |
| Crodamide ER | 0.2 |
| Total | 100 |
| Crodamide ER (dusting) | 0.2 |
| Pantone Blue 279 C Pigment | 8 |

A formulation for a blue thermoplastic elastomer composition that is X-ray detectable, metal detectable, has magnetic susceptibility, is ATEX compliant and has electro-static discharge, and has surface resistivity at 15 mils per ESD S11.11 (23° C./50% relative humidity) is 3.98×10⁸ includes:

| material | % formulation |
|---|---|
| TPU D15N85 | 44.8 |
| Pelestat 230 | 25 |
| Magnif 10F | 10 |
| TiO₂ | 20 |
| Acrawax C or Sinwon Hi-Lube | 0.2 |
| Total | 100 |
| Crodamide ER (dusting) | 0.2 |
| Pantone Blue 279 C Pigment | 8 |

A formulation for a blue thermoplastic elastomer composition that is X-ray detectable, metal detectable, has magnetic susceptibility, is ATEX compliant and has electro-static discharge, and has surface resistivity at 15 mils per ESD S11.11 (23° C./50% relative humidity) is 1.59×10³ to 1.33×10⁵ includes:

| material | % formulation |
|---|---|
| TPU D15N85 | 63.8 |
| AC80 | 6 |
| Magnif 10F | 10 |
| TiO₂ | 20 |
| Acrawax C or Sinwon Hi-Lube | 0.2 |
| Total | 100 |
| Crodamide ER (dusting) | 0.2 |
| Pantone Blue 279 C Pigment | 8 |

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

What is claimed is:

1. A thermoplastic elastomer composition comprising at least one thermoplastic elastomer, at least one metal detectable agent, and at least one x-ray detectable agent.

2. The thermoplastic elastomer composition of claim 1, further comprising at least one anti-static agent.

3. The thermoplastic elastomer composition of claim 1, further comprising at least one additional additive selected from the group consisting of hardeners, impact modifiers, fillers, adhesion agents, chemical resistance agents, abrasion resistant agents, colorants, dyes, pigments, antioxidants, heat stabilizers, light stabilizers, UV light stabilizers, plasticizers, lubricants, mold release agents, flame retardants, anti-drip agents, gamma stabilizers, and any combination thereof.

4. The thermoplastic elastomer composition of claim 1, further comprising at least one lubricant.

5. The thermoplastic elastomer composition of claim 2, further comprising at least one lubricant.

6. The thermoplastic elastomer composition of claim 1, further comprising at least one lubricant and at least one colorant.

7. The thermoplastic elastomer composition of claim 2, further comprising at least one lubricant and at least one colorant.

8. The thermoplastic elastomer composition of claim 1, wherein the at least one thermoplastic elastomer comprises a species selected from the group consisting of vibration damping thermoplastic elastomer (VDT), thermoplastic polyurethane (TPU), thermoplastic vulcanizate (TPV), thermoplastic polyolefins (TPO), thermoplastic copolyester elastomer (TPC), polyamide thermoplastic elastomer (TPA), thermoplastic styrenic elastomer (TPS), styrene copolymer (e.g., a styrene-butadiene block copolymer (SBC)), and combinations thereof.

9. The thermoplastic elastomer composition of claim 1, wherein the at least one thermoplastic elastomer comprises thermoplastic polyurethane (TPU).

10. The thermoplastic elastomer composition of claim 1, wherein the at least one metal detectable agent comprises magnetite.

11. The thermoplastic elastomer composition of claim 1, wherein the at least one x-ray detectable agent is selected from the group consisting of zinc oxide, titanium dioxide, iron oxide, chromium oxide, cerium oxide, colored alumina oxide particles, calcium carbonate, cobalt carbonate, chromium antimony titanate, nickel antimony titanate, cobalt titanate, iron titanate, copper chromite black, cobalt chromite green, pure ferrite spinels that contain magnesium and zinc, mixed chromite/ferrite spinels, mixed chromium iron pigments, cadmium sulfides, cadmium sulfoselenides, cerium sulfide, zinc sulfide, barium sulfate, strontium sulfate ultramarine, zirconium silicate, zircon praseodymium yellow pigment, Fe(II)—Fe(III) cyano complexes, calcium oxide-nitride, lanthanum oxide-nitride, tantalum oxide-nitride, titanium nitride, manganese phosphate, cobalt phosphate, titania-rare earth mixed oxide pigments, sulfoselenide, alkaline-earth sulfide, alkaline-earth sulfoselenides, and combinations thereof.

12. The thermoplastic elastomer composition of claim 1, wherein the at least one x-ray detectable agent comprises titanium dioxide.

13. The thermoplastic elastomer composition of claim 2, wherein the at least one anti-static agent is selected from the group consisting of polyether ester amide-based high molecular weight type anti-static agents, ionomer-based high molecular weight type anti-static agents, carbon black, and any combination thereof.

14. The thermoplastic elastomer composition of claim 2, wherein the at least one anti-static agent is selected from polyether ester amide-based high molecular weight type anti-static agents and carbon black.

15. The thermoplastic elastomer composition of claim 4, wherein the at least one lubricant is homogeneously distributed in the composition.

16. The thermoplastic elastomer composition of claim 4, wherein the at least one lubricant comprises an ethylenebisamide wax.

17. The thermoplastic elastomer composition of claim 1, comprising at least one thermoplastic elastomer in an amount from about 40 wt % to about 80 wt %, at least one metal detectable agent in an amount of about 0.01 wt % to about 15 wt %, and at least one x-ray detectable agent in an amount of about 5 wt % to about 30 wt %, based on the total weight of the composition.

18. The thermoplastic elastomer composition of claim 17, further comprising at least one anti-static agent in an amount of about 1 wt % to about 35 wt %, based on the total weight of the composition.

19. The thermoplastic elastomer composition of claim 17, further comprising at least one lubricant in an amount of about 0.01 wt % to about 1 wt %, based on the total weight of the composition.

20. The thermoplastic elastomer composition of claim 17, further comprising at least one colorant in an amount of about 1 wt % to about 15 wt %, based on the total weight of the composition.
